(19) United States
(12) Patent Application Publication
(10) Pub. No.: US 2026/0360317 A1
(43) Pub. Date: Nov. 12, 2026

(54) DISPLAY DEVICE AND ELECTRONIC DEVICE INCLUDING THE SAME

(71) Applicant: SAMSUNG DISPLAY CO., LTD., YONGIN-SI (KR)

(72) Inventors: JONG HEON HAN, Yongin-si (KR); JINSEUK KIM, Yongin-si (KR); SEOK-HOON YOON, Yongin-si (KR)

(21) Appl. No.: 19/557,917

(22) Filed: Mar. 5, 2026

(30) Foreign Application Priority Data
May 12, 2025 (KR) 10-2025-0061241

(51) Int. Cl. G09G 3/3266

(52) U.S. Cl. CPC G09G 3/3266; G09G 2320/0233; G09G 2380/02

(57) ABSTRACT

A display device according to the disclosure includes a display panel including a display area in which pixels are disposed and a non-display area adjacent to the display area, a gate driving circuit disposed in the non-display area of the display panel and configured to provide a gate signal to the pixels, a driving chip configured to provide a data signal to the display panel and configured to provide a gate control signal to the gate driving circuit, a flexible circuit film connected to the driving chip and including a main pad configured to be used in a normal mode and a test pad configured to be used in a test mode, and a switching circuit connected between the test pad and an output terminal of the gate driving circuit and configured to be activated in the test mode.

### CROSS-REFERENCE TO RELATED APPLICATION(S)

This application is based on and claims priority under 35 U.S.C. § 119 to and benefits from Korean Patent Application No. 10-2025-0061241 filed on May 12, 2025 in the Korean Intellectual Property Office, the entire disclosure of which is incorporated by reference herein.

### Background

The disclosure relates to a display device with improved reliability and an electronic device that includes the same.

### Discussion of the Related Art

Multimedia electronic devices such as a television, a mobile phone, a tablet, a navigation system, a game machine, and the like include a display device for displaying an image.

The display device includes a display panel in which pixels are arranged. The pixels generally comprise a light-emitting diode and pixel circuit for controlling the amount of current flowing into the light-emitting diode. The pixel circuit is coupled to a data line that receives a data signal and a gate line that receives a gate signal.

The display device includes a gate driving circuit that supplies the gate signal to the gate line and a data driving circuit that supplies the data signal to the data line. Display characteristics of the display device may vary depending on characteristics of the gate driving circuit and the data driving circuit. Therefore, it is necessary to inspect the gate driving circuit and the data driving circuit to identify the cause of the operation failure, the image quality failure, and the like of the display device.

### SUMMARY

An object of the disclosure is to provide a display device that may readily inspect a gate driving circuit, and an electronic device including the same.

Embodiments of the disclosure provide a display device that includes a display panel including a display area in which a plurality of pixels are disposed and a non-display area adjacent to the display area, a gate driving circuit disposed in the non-display area of the display panel and configured to provide a gate signal to the pixels, a driving chip configured to provide a data signal to the plurality of pixels and configured to provide a gate control signal to the gate driving circuit, a flexible circuit film connected to the driving chip, the flexible film including a main pad configured to be used in a normal mode and a test pad configured to be used in a test mode, and a switching circuit connected between the test pad and an output terminal of the gate driving circuit and configured to be activated in the test mode.

According to an embodiment of the disclosure, the switching circuit may be connected to the driving chip and may be configured to be activated in the test mode in response to a switching signal provided from the driving chip, and the switching circuit may be configured to be deactivated in the normal mode.

According to an embodiment of the disclosure, the switching circuit may include at least one switching transistor connected between the output terminal and the test pad.

According to an embodiment of the disclosure, the at least one switching transistor may include a first switching transistor including a first electrode connected to the output terminal, a second electrode, and a control electrode configured to receive the switching signal, and a second switching transistor including a first electrode connected to the second electrode of the first switching transistor, a second electrode connected to the test pad, and a control electrode configured to receive the switching signal.

According to an embodiment of the disclosure, each of the first and the second switching transistors may be a PMOS transistor or an NMOS transistor.

According to an embodiment of the disclosure, the switching circuit may be connected to the driving chip and may be configured to be activated in the test mode in response to first and second sub-switching signals provided from the driving chip, the switching circuit may be configured to be deactivated in the normal mode, and the first sub-switching signal may be an inverted signal of the second sub-switching signal.

According to an embodiment of the disclosure, the switching circuit may include a first switching transistor including a first electrode connected to the output terminal, a second electrode, and a control electrode configured to receive the first sub-switching signal, and a second switching transistor including a first electrode connected to the second electrode of the first switching transistor, a second electrode connected to the test pad, and a control electrode configured to receive the second sub-switching signal.

According to an embodiment of the disclosure, the first and the second switching transistors may be of different types.

According to an embodiment of the disclosure, the driving chip may be mounted in the non-display area of the display panel.

According to an embodiment of the disclosure, the gate driving circuit may include a first gate driving circuit disposed adjacent to a first side of the display area, and a second gate driving circuit disposed adjacent to a second side of the display area opposite to the first side, the test pad may include a first side test pad and a second side test pad.

According to an embodiment of the disclosure, the switching circuit may include a first switching circuit connected between an output terminal of the first gate driving circuit and the first side test pad and a second switching circuit connected between an output terminal of the second gate driving circuit and the second side test pad.

According to an embodiment of the disclosure, the first switching circuit may be connected to the driving chip and may be configured to receive a first switching signal from the driving chip, and the second switching circuit may be connected to the driving chip and may be configured to receive a second switching signal from the driving chip, the first and second switching circuits may be activated in the test mode and deactivated in the normal mode.

According to an embodiment of the disclosure, the display panel may also include a plurality of gate lines connected to the gate driving circuit and configured to receive the gate signal, the output terminal of the gate driving circuit may be configured to provide the gate signal to one of the plurality of gate lines.

According to an embodiment of the disclosure, the display panel may also include a plurality of gate lines connected to the gate driving circuit and configured to receive the gate signal, the output terminal of the gate driving circuit may not be connected to any of the plurality of gate lines, and the output terminal may be a dummy output terminal that outputs a dummy gate signal.

According to an embodiment of the disclosure, the display panel may also include a bending area that is configured to be bent with respect to a bending axis, the switching circuit may be disposed between the display area and the bending area.

According to an embodiment of the disclosure, the test mode may be a mode monitoring a signal output through the output terminal of the gate driving circuit.

According to an embodiment of the disclosure, the gate driving circuit may include at least one scan driving circuit configured to generate at least one scan signal, and a light emission driving circuit configured to generate a light emission control signal, and the switching circuit may include a first sub-switching circuit connected to the at least one scan driving circuit, and a second sub-switching circuit connected to the light emission driving circuit.

Embodiments of the disclosure provide an electronic device that includes a display panel including a display area in which a plurality of pixels are disposed and a non-display area adjacent to the display area, a gate driving circuit disposed in the non-display area of the display panel and configured to provide a gate signal to the pixels, a driving chip configured to provide a data signal to the plurality of pixels and configured to supply a gate control signal to the gate driving circuit, a flexible circuit film connected to the driving chip, the flexible circuit film including a main pad configured to be used in a normal mode and a test pad configured to be used in a test mode, a switching circuit connected between the test pad and an output terminal of the gate driving circuit and configured to be activated in the test mode, and a processor configured to provide a control signal and an image signal to the driving chip.

According to an embodiment of the disclosure, the display panel may also include a plurality of gate lines connected to the gate driving circuit and configured to receive the gate signal, the output terminal of the gate driving circuit may be configured to provide the gate signal to one of the plurality of gate lines.

According to an embodiment of the disclosure, the display panel may also include a plurality of gate lines connected to the gate driving circuit and configured to receive the gate signal, the output terminal of the gate driving circuit may not be connected to any of the plurality of gate lines, and the output terminal may be a dummy output terminal that is configured to output a dummy gate signal.

### BRIEF DESCRIPTION OF THE DRAWINGS

The above and other objects and features of the present disclosure will become apparent by describing in detail embodiments thereof with reference to the accompanying drawings.

FIG. 1A is a perspective view of a display device according to an embodiment of the disclosure.

FIG. 1B is an exploded perspective view of a display device according to an embodiment of the disclosure.

FIG. 1C is a cross-sectional view taken along a cutting line I-I′ shown in FIG. 1B.

FIG. 2 is a plan view of a display panel according to an embodiment of the disclosure.

FIG. 3 is a circuit diagram of a pixel according to an embodiment of the disclosure.

FIG. 4 is a cross-sectional view showing a partial area of the display module shown in FIG. 1C.

FIG. 5 is a block diagram illustrating a driving chip according to an embodiment of the disclosure.

FIG. 6 is a block diagram illustrating a connection relationship between the first and second gate driving circuits and the test pad according to an embodiment of the disclosure.

FIG. 7A is a diagram illustrating a connection between the first scan driving circuit and the first-first switching circuit illustrated in FIG. 6.

FIG. 7B is a diagram illustrating a connection between the third scan driving circuit and the second-first switching circuit illustrated in FIG. 6.

FIG. 8A is a diagram illustrating a connection between a first scan driving circuit and a first-first switching circuit according to an embodiment of the disclosure.

FIG. 8B is a diagram illustrating a connection between a third scan driving circuit and a second-first switching circuit according to an embodiment of the disclosure.

FIG. 9 is a diagram illustrating an internal configuration of a first-first switching circuit according to an embodiment of the disclosure.

FIG. 10 is a diagram illustrating an internal configuration of a first-first switching circuit according to an embodiment of the disclosure.

FIG. 11 is a block diagram of an electronic device according to an embodiment.

FIG. 12 is a schematic diagram illustrating embodiments of various electronic devices.

### DETAILED DESCRIPTION OF EMBODIMENTS

In this specification, it will be understood that when an element (or a region, a layer, a portion, or the like) is referred to as being "on", "connected to" or "coupled to" another element, it may be disposed on (e.g., ‘directly on’), connected to, or coupled to another element, or other elements may be disposed therebetween.

Moreover, in the accompanying drawings, the thicknesses, ratios, and dimensions of the elements might not be to exact scale and may have been exaggerated for the benefit of effective explanation of the technical features associated with these elements. As such, the present disclosure shall not be restricted to the thicknesses, ratios, dimensions, etc. illustrated in the drawings. Like reference numerals or symbols refer to like elements throughout. As used herein, the term "and/or" includes any and all combinations of one or more of the associated listed elements.

It will be understood that, although the terms “first”, “second”, etc. may be used herein to describe various elements, the elements are not to be limited by these terms. These terms are only used to distinguish one element, component, region, layer or section from another element, component, region, layer or section. For instance, a first element, component, region, layer or section discussed below could be termed a second element, component, region, layer or section without departing from the scope of the disclosure. Similarly, a second element, component, region, layer or section could be termed a first element, component, region, layer or section. In this specification, the singular expressions "a", "an" and "the" are intended to include the plural forms as well, unless the context clearly indicates otherwise.

The terms "below", “under”, "on the lower side", "above", “over”, "on the upper side", or the like may be used to describe the relationships between the elements illustrated in the drawings. These terms are relative concepts and are described on the basis of the directions indicated in the drawings.

It will be further understood that the terms "comprises, includes, has" and/or "comprising, including, having", when used in this specification, specify the presence of stated features, numbers, steps, operations, elements, components or combinations thereof, but do not preclude the possibility of the presence or addition of one or more other features, numbers, steps, operations, elements, components, and/or combinations thereof.

Unless otherwise defined, all terms (including technical and scientific terms) used herein have the same meaning as commonly understood by one of ordinary skill in the art to which the disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to embodiments of the disclosure, there is provided a design for display device and an electronic device that includes the same that can readily inspect a gate driving circuit. The display device may operate in a normal mode where an image is displayed and in a test mode where a gate signal supplied by a gate driving circuit is inspected. Switching circuits may be included that connect a gate line connected to an output port of the gate driver to a test pad. The display device may also include a driving chip that serves as a data driver, that supplies a gate control signal to control the gate driving circuits, and that supplies switching signals to the switching circuits to allow for transmission of the gate signal to a test pad for inspection. The gate signal transmitted to the test pad may be from a same gate line that is used to deliver scan signals to pixels in a normal mode, or may be from a dummy line dedicated to inspection of the gate signals to avoid load variations in gate lines.

The switching circuit may take various forms, but is generally a pair of transistors connected in series between the gate line and the test pad. In test mode, the switching signals may be activated to turn on the switching circuit so that the sampled gate line is connected to the test pad to allow for inspection of the gate signal. During normal mode, the switching signal may be deactivated to electrically disconnect the gate line from the test pad. As a result, gate signals may be transmitted to the test pad for inspection in a manner that minimizes interference with the normal display operation of the display panel.

Hereinafter, embodiments of the disclosure are described with reference to the drawings.

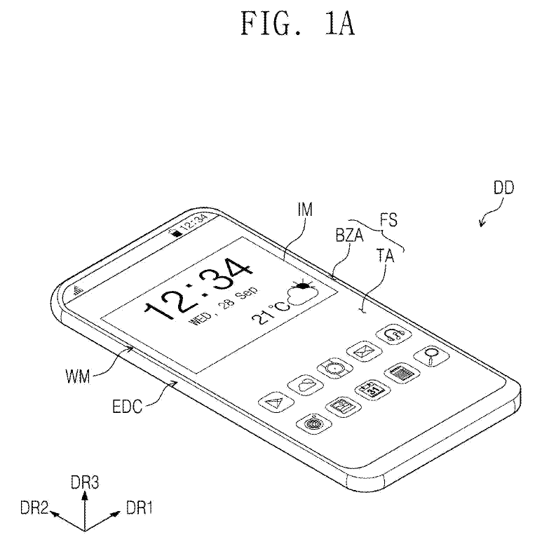

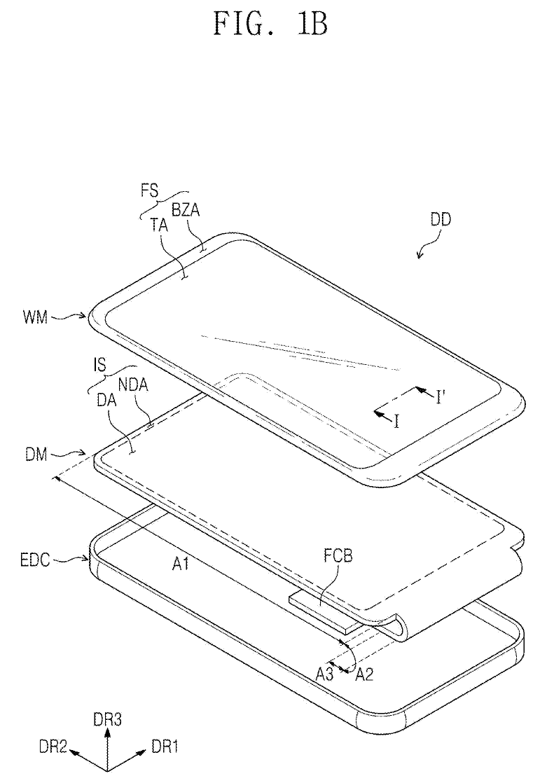

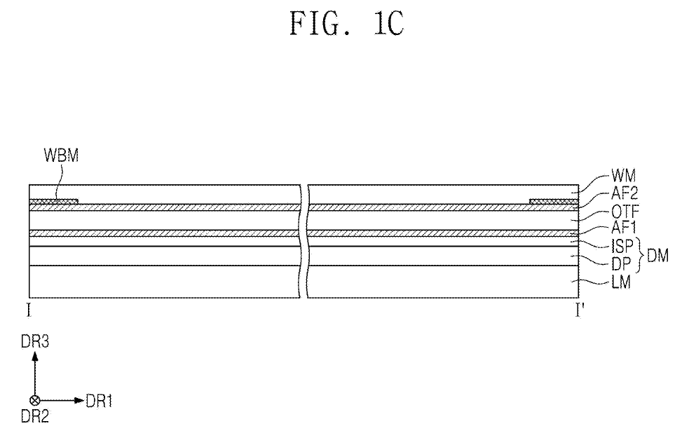

FIG. 1A is a perspective view of a display device according to an embodiment. FIG. 1B is an exploded perspective view of a display device according to an embodiment. FIG. 1C is a cross-sectional view taken along a cutting line I-I′ shown in FIG. 1B.

Referring to FIGS. 1A-1C, the display device DD may be a device that is activated according to an electrical signal and displays an image. For example, the display device DD can be utilized in large-sized electronic devices such as televisions, external billboards, and the like, as well as small and medium-sized electronic devices such as computer monitors, mobile phones, tablets, computers, navigation devices, game machines, and the like. Embodiments of the display device DD are illustrative and are not necessarily limited to any one unless they depart from the concept of the disclosure. In this embodiment, as an example of the display device DD, a structure employed in a mobile phone is illustrated.

Referring to FIG. 1A, the display device DD may have a rectangular shape having short sides extending in a first direction DR1 in a plan view and long sides extending in a second direction DR2 intersecting the first direction DR1. However, embodiments of the disclosure are not necessarily limited thereto, and the display device DD may have various shapes such as a circle shape, a polygon shape, and the like in a plan view.

The display device DD according to an embodiment may be a flexible display device. “Flexible” refers to a property of being bent, and may include everything from a structure capable of being fully folded to a structure capable of being bent to a level of several nanometers. For example, the flexible display device DD may include a curved display device or a foldable display device. However, embodiments of the disclosure are not necessarily limited thereto, and the display device DD may be a rigid display device.

The display device DD may display the image IM toward a third direction DR3 on a display surface parallel to each of the first direction DR1 and the second direction DR2. The image IM displayed in the display device DD may include a still image as well as a dynamic image. In FIG. 1A, a watch window and icons are illustrated as an example of the image IM.

The display surface on which the image IM is displayed may correspond to a front surface of the display device DD. The front surface of the display device DD may correspond to a front surface FS of the window WM. On the other hand, FIG. 1A exemplarily illustrates a substantially flat display surface, but embodiments of the disclosure are not necessarily limited thereto, and the display surface of the display device DD may include a curved surface bent from at least one side of a substantially flat surface.

The front surfaces (or the upper surfaces) and the rear surfaces (or the lower surfaces) of the members constituting the display device DD may be opposed to each other in the third direction DR3, and the normal direction of each of the front surface and the rear surface may be substantially parallel to the third direction DR3. The separation distance between the front surface and the rear surface defined in the third direction DR3 may correspond to the thickness of the member (or unit). In this specification, “on a plane” may be defined as a state viewed in the third direction DR3. In this specification, “on a cross-section” may be defined as a state viewed in the first direction DR1 or the second direction DR2. Directions indicated by the first to third directions DR1, DR2, and DR3 may be relative concepts and may be changed to other directions.

Referring to FIGS. 1A and 1B, the display device DD may include a window WM, a display module DM, and a case EDC. The window WM and the case EDC may be combined to form the appearance of the display device DD, and may provide an internal space capable of accommodating the components of the display device DD.

The window WM may be disposed on the display module DM. The window WM may have a shape corresponding to a shape of the display module DM. The window WM may cover the entire outside of the display module DM, and may protect the display module DM from external impacts and scratches.

The window WM may include an optically clear insulating material. For example, the window WM may include a glass substrate or a polymer substrate. The window WM may have a single-layer structure or a multi-layer structure. The window WM may further include functional layers such as an anti-fingerprint layer, a phase control layer, and a hard coat layer, which are disposed on the transparent substrate.

The front surface FS of the window WM may include a transmission area TA and a bezel area BZA. The transmission area TA of the window WM may be an optically clear area. The window WM may transmit the image IM provided by the display panel DP through the transmission area TA, and the user may visually recognize the image IM.

The bezel area BZA of the window WM may be an area in which a light shielding pattern WBM (see FIG. 1C) including a color (e.g., predetermined or selectable color) is printed. The bezel area BZA of the window WM may prevent a component of the display module DM disposed to overlap the bezel area BZA from being visible from the outside.

The bezel area BZA may be adjacent to the transmissive area TA. The shape of the transmission area TA may be substantially defined by the bezel area BZA. For example, the bezel area BZA may be disposed outside the transmission area TA to surround the transmission area TA. However, this is illustrated as an example, and the bezel area BZA may be adjacent to a single side of the transmission area TA or may be omitted. The bezel area BZA may be disposed on a side surface of the display device DD instead of the front surface.

As illustrated in FIGS. 1B and 1C, the display module DM may be disposed between the window WM and the case EDC. The image IM provided by the display device DD may be displayed on a front surface IS of the display module DM. The front surface IS of the display module DM may include a display area DA and a non-display area NDA. The display area DA may be an area that is activated according to an electrical signal and displays the image IM. According to an embodiment, the display area DA of the display module DM may correspond to the transmission area TA of the window WM.

On the other hand, in this specification, “area/portion and area/portion correspond” means “area/portion and area/portion overlap each other” and is not necessarily limited to the areas/portions having the same area and/or the same shape.

The non-display area NDA may be adjacent to the outside of the display area DA. For example, the non-display area NDA may surround the display area DA. However, embodiments of the disclosure are not necessarily limited thereto, and the non-display area NDA may be defined in various shapes.

The non-display area NDA may be an area in which a driving circuit or a driving wiring for driving elements disposed in the display area DA, various signal lines for providing an electrical signal to the elements, pads, and the like are disposed. The non-display area NDA of the display module DM may correspond to the bezel area BZA of the window WM. The bezel area BZA may prevent components of the display module DM disposed in the non-display area NDA from being visible from the outside.

The display module DM may include a display panel DP and an input sensing layer ISP. The display panel DP according to an embodiment of the disclosure may be a light-emitting display panel, and is not particularly limited. For example, the display panel DP may be an organic light-emitting display panel, an inorganic light-emitting display panel or a quantum dot light-emitting display panel. A light-emitting layer of the organic light-emitting display panel may include an organic light-emitting material, and a light-emitting layer of an inorganic light-emitting display panel includes an inorganic light-emitting material. A light-emitting layer of the quantum dot light-emitting display panel may include a quantum dot, a quantum rod, and the like. Hereinafter, the display panel DP will be described as an organic light-emitting display panel.

The input sensing layer ISP may be disposed on (e.g., ‘directly on’) the display panel DP. According to an embodiment of the disclosure, the input sensing layer ISP may be formed on the display panel DP by a continuous process. For example, when the input sensing layer ISP is disposed on (e.g., ‘directly on’) the display panel DP, an adhesive film is not disposed between the input sensing layer 1SP and the display panel DP.

The display panel DP generates an image IM, and the input sensing layer ISP acquires coordinate information of an external input (e.g., a touch event).

The display module DM may include a first area A1, a second area A2, and a third area A3 arranged in the second direction DR2. The first area A1 may be an area corresponding to the display surface IS. The second area A2 and the third area A3 may be included in the non-display area NDA. The second area A2 may be a bending area that is bent with respect to a bending axis, and the first and third areas A1 and A3 may be non-bending areas. The lengths of the second area A2 and the third area A3 in the first direction DR1 may be less than or substantially equal to the length of the first area A1. An area having a short length in the bending axis direction may be more readily bent.

The display device DD may further include a flexible circuit film FCB connected to the display module DM. The flexible circuit film FCB may be connected to the third area A3 of the display module DM. The flexible circuit film FCB may provide an electrical signal to the display module DM.

At least a part (for example, the second area A2) of the non-display area NDA of the display module DM may be bent. The flexible circuit film FCB connected to the third area A3 of the display module DM may be disposed and assembled to overlap the rear surface of the display module DM in a plan view.

The display device DD according to an embodiment may further include an optical film OTF and a lower module LM. The optical film OTF reduces the reflectance of external light incident from the upper side of the window WM. The optical film OTF according to an embodiment of the disclosure may include a phase retarder and a polarizer. The phase retarder may be a film type or a liquid crystal coating type, and may include a λ/2 phase retarder and/or a λ/4 phase retarder. The polarizer may also be a film type or a liquid crystal coating type. The film type includes a stretchable synthetic resin film, and the liquid crystal coating type may include liquid crystals arranged in an arrangement (e.g., ‘predetermined or selectable arrangement’). The phase retarder and the polarizer may be implemented as one polarizing film. The optical film OTF may further include a protective film disposed above or below the polarizing film.

The optical film OTF may be disposed on the input sensing layer ISP. For example, the optical film OTF may be disposed between the input sensing layer ISP and the window WM. The input sensing layer ISP, the optical film OTF, and the window WM may be coupled to each other through adhesive films. A first adhesive film AF1 is disposed between the input sensing layer ISP and the optical film OTF, and a second adhesive film AF2 is disposed between the optical film OTF and the window WM. Thus, the optical film OTF is coupled to the input sensing layer ISP by the first adhesive film AF1, and the window WM is coupled to the optical film OTF by the second adhesive film AF2.

As an example of the disclosure, each of the first and second adhesive films AF1 and AF2 may include an optically clear adhesive film (OCA film). However, the material of each of the first and second adhesive films AF1 and AF2 is not necessarily limited thereto, and may include a conventional adhesive. For example, each of the first and second adhesive films AF1 and AF2 may include a pressure sensitive adhesive (PSA), an optically clear adhesive (OCA), or an optically clear resin (OCR).

A functional layer that performs a function other than the optical film OTF, for example, a protective layer, may be further disposed between the display module DM and the window WM.

The lower module LM is disposed below the rear surface of the display module DM. The lower module LM may be disposed below the rear surface of the display module DM to improve the impact resistance of the display device DD. The lower module LM may be fixed to the rear surface of the display module DM through an adhesive film. The adhesive film may be a pressure sensitive adhesive (PSA), an optical clear adhesive (OCA), or an optical clear resin (OCR).

The case EDC may be disposed under the display module DM to accommodate the display module DM. The case EDC may include a glass, plastic, or metal material having relatively high rigidity. The case EDC may protect the display module DM by absorbing impact applied to the display module DM from the outside and preventing infiltration of foreign material, external moisture, or the like into the display module DM.

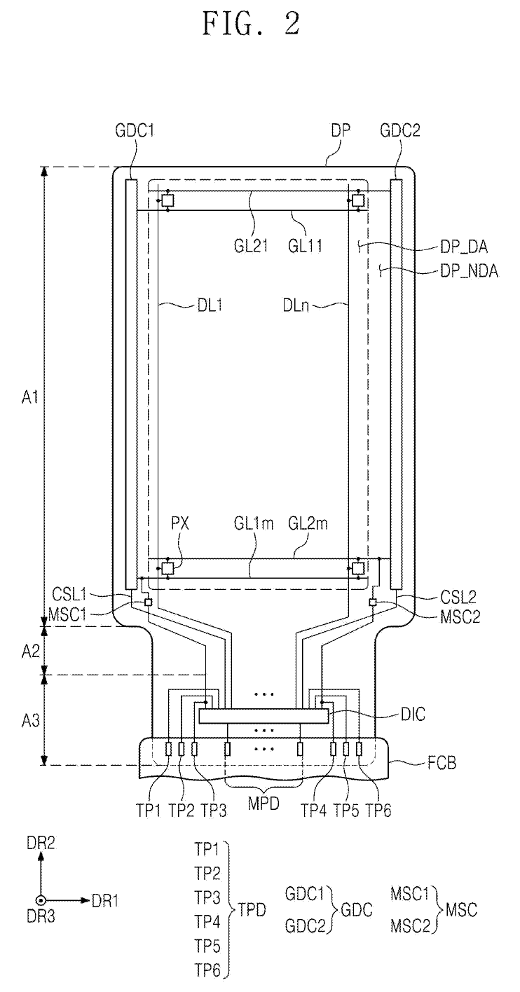

FIG. 2 is a plan view of a display module according to an embodiment of the disclosure.

Referring to FIG. 2, the display module DM according to an embodiment of the disclosure may include a display panel DP, a gate driving circuit GDC, a driving chip DIC, and a flexible circuit film FCB. The display panel DP may be divided into a first area A1, a second area A2, and a third area A3. The first to third areas A1, A2, and A3 of the display panel DP illustrated in FIG. 2 may correspond to the first to third areas A1, A2, and A3 of the display module DM described in FIG. 1B, respectively. In this specification, “one area/portion” and “another area/portion correspond” means “one area/portion and another area/portion overlap each other” and is not necessarily limited to meaning the areas/portions having the same area as each other.

The display panel DP according to an embodiment may include a display area DP_DA in which the pixel PX is disposed and a non-display area DP_NDA adjacent to the display area DP_ DA. The display area DP_DA and the non-display area DP_NDA correspond to the display area DA and the non-display area NDA of the display module DM described with reference to FIG. 1B, respectively. The display area DP_DA may correspond to an area in which the pixel PX is disposed in the first area A1, and the non-display area DP_NDA may include the second area A2, the third area A3, and a remaining portion of the first area A1 external to a portion occupied by the pixels PX.

The display module DM may further include a gate driving circuit GDC and a driving chip DIC disposed in the non-display area DP_NDA of the display panel DP.

The display panel DP may include multiple pixels PX, multiple first gate lines GL11 to GL1m, multiple second gate lines GL21 to GL2m, and multiple data lines DL1 to DLn. Here, m and n are natural numbers. The pixels PX may be connected to the first gate lines GL11 to GL1m, the second gate lines GL21 to GL2m, and the data lines DL1 to DLn.

The first gate lines GL11 to GL1m and the second gate lines GL21 to GL2m may extend in the first direction DR1. The data lines DL1 to DLn may extend in the second direction DR2 in the first area A1 and may be connected to the driving chip DIC disposed in the third area A3 via the second area A2. As an example of the disclosure, the driving chip DIC may be mounted on the display panel DP, but embodiments of the disclosure are not necessarily limited thereto. For example, the driving chip DIC may be disposed on a connection film or a circuit board.

The gate driving circuit GDC may include a first gate driving circuit GDC1 adjacent to a first side of the display area DP_DA and a second gate driving circuit GDC2 adjacent to a second side opposite to the first side of the display area DP_DA. The first gate driving circuit GDC1 may be connected to the driving chip DIC through a first control line CSL1, and the second gate driving circuit GDC2 may be connected to the driving chip DIC through a second control line CSL2. The first gate driving circuit GDC1 may apply first gate signals to the first gate lines GL11 to GL1m, and the second gate driving circuit GDC2 may apply second gate signals to the second gate lines GL21 to GL2m.

The display panel DP may further include a power supply line that supplies a driving voltage to the pixels PX. The power supply line may be arranged in a mesh shape in the display area DP_DA.

The driving chip DIC may be mounted on the non-display area DP_NDA of the display panel DP. In particular, the driving chip DIC may be mounted on the third area A3 in the non-display area DP_NDA. The driving chip DIC may be connected to the data lines DL1 to DLn, and may apply data voltages to the data lines DL1-DLn.

Pads may be disposed at the end of the third area A3 of the display panel DP. The driving chip DIC may be connected to the pads. The flexible circuit film FCB may overlap the end of the third area A3 of the display panel DP and may be coupled to the display panel DP. The flexible circuit film FCB may include main pads MPD utilized in a normal mode and test pads TPD utilized in a test mode. The main pads MPD and the test pads TPD may correspond to the pads of the display panel DP.

The test pads TPD may be electrically connected to the driving chip DIC. As an example of the disclosure, the test pads TPD may include first to third test pads TP1 to TP3 (or referred to as first-side test pads) disposed adjacent to a first side (e.g., a left side) of the driving chip DIC and fourth to sixth test pads TP4 to TP6 (or referred to a second-side test pads) disposed adjacent to a second side (e. g., a right side) of the driving chip DIC.

The display module DM may further include a switching circuit MSC connected between the test pads TPD and an output terminal of the gate driving circuit GDC and may be activated in the test mode. The switching circuit MSC may include a first switching circuit MSC1 connected to at least one of the first to third test pads TP1 to TP3, and a second switching circuit MSC2 connected to at least one of the fourth to sixth test pads TP4 to TP6. The test mode may be a mode in which a signal output through an output terminal of the gate driving circuit GDC is monitored, and the normal mode may be a mode in which the display device DD displays an image.

The output terminal of the gate driving circuit GDC may be a terminal that provides a gate signal to one of the gate lines GL11 to GL1m and GL21 to GL2m. As another example, the output terminal of the gate driving circuit GDC may be a dummy output terminal that is not connected to the gate lines GL11 to GL1m and GL21 to GL2m and may output a dummy gate signal.

FIG. 2 illustrates a structure in which the first switching circuit MSC1 is connected to the first test pad TP1 among the first to third test pads TP1 to TP3, but embodiments of the disclosure are not necessarily limited thereto. The first switching circuit MSC1 may be connected to all of the first to third test pads TP1 to TP3, or may be connected to two selected test pads among the first to third testing pads TP1 to TP3 or one selected test pad among the first to third testing pads TP1 to TP3. Similarly, FIG. 2 illustrates a structure in which the second switching circuit MSC2 is connected to the fourth test pad TP4 among the fourth to sixth test pads TP4 to TP6, but embodiments of the disclosure are not necessarily limited thereto. The second switching circuit MSC2 may be connected to all of the fourth to sixth test pads TP4 to TP6, or may be connected to two selected test pads among the fourth to sixth testing pads TP4 to TP6 or one selected test pad among the fourth to sixth testing pads TP4 to TP6.

The first switching circuit MSC1 may be connected between the output terminal of the first gate driving circuit GDC1 and the first test pad TP1, and the second switching circuit MSC2 may be connected between the output terminal of the second gate driving circuit GDC2 and the fourth test pad TP4. As an example of the disclosure, the output terminal of the first gate driving circuit GDC1 may be a terminal connected to a selected one of the first gate lines GL11 to GL1m (e.g., the first-m gate line GL1m), and the output terminal of the second gate driving circuit GDC2 may be a terminal coupled to a selected one among the second gate lines GL21 to GL2m (e. g., the second-m gate line GL2m).

As an example of the disclosure, the first switching circuit MSC1 may be disposed between the first gate driving circuit GDC1 and the second area A2, and the second switching circuit MSC2 may be disposed between the second area A2 and the second gate driving circuit GDC2. For example, the first and second switching circuits MSC1 and MSC2 may not overlap with the bending area (for example, the second area A2) of the display panel DP.

The display module DM may further include a selection circuit disposed between the driving chip DIC and the data lines DL1 to DLn. The selection circuit may be a circuit that selectively applies data voltages output from the driving chip DIC to some of the data lines DL1 to DLn.

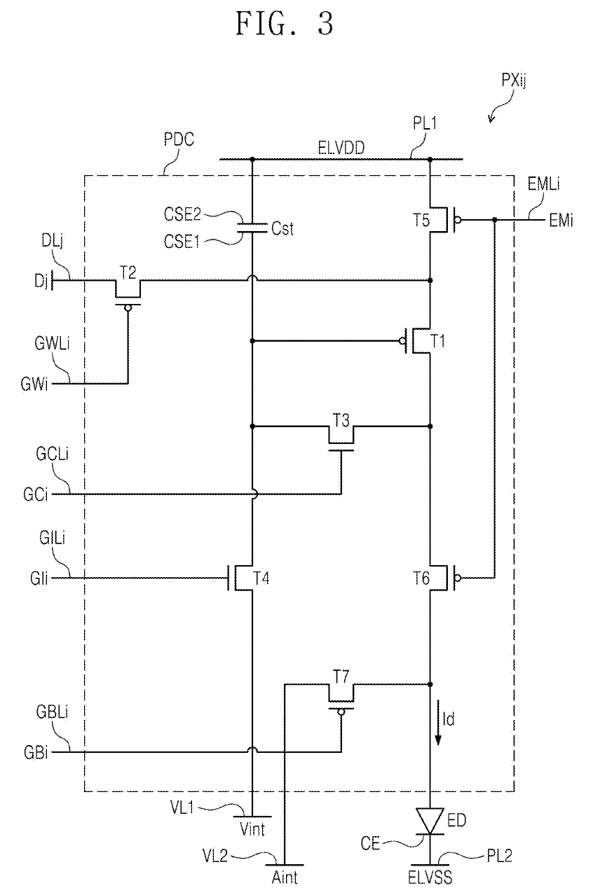

FIG. 3 is a circuit diagram of a pixel according to an embodiment of the disclosure. FIG. 3 illustrates an equivalent circuit diagram of a single pixel PXij among the pixels PX illustrated in FIG. 2.

Referring to FIG. 3, the pixel PXij may include a light-emitting element ED and a pixel driving circuit PDC.

The pixel driving circuit PDC may include multiple transistors T1 to T7 and a storage capacitor Cst. The pixel driving circuit PDC may be electrically connected to i-th gate lines GWLi, GCLi, GILi, GBLi, and EMLi, a j-th data line DLj, a first initialization voltage line VL1, a second initialization voltage line VL2, and a first power supply line PL1. The j-th data line DLj applies a data voltage Dj to the pixel PXij. The first power supply line PL1 applies a first driving voltage ELVDD to the pixel PXij, and the first and second initialization voltage lines VL1 and VL2 apply first and second initialization voltages Vint and Aint to the pixels PXij, respectively.

As an example of the disclosure, the transistors T1 to T7 may include first to seventh transistors T1 and T7. Some of the first to seventh transistors T1 to T7 may be NMOS transistors, and others of the first to seventh transistors T1 to T7 may be PMOS transistors. For example, the third and fourth transistors T3 and T4 may be NMOS transistors, and the first, second, and fifth to seventh transistors T1, T2, and T5 to T7 may be PMOS transistors. In an embodiment, the third transistor T3, the fourth transistor T4, and the seventh transistor T7 may be NMOS transistors, and the first, second, fifth, and sixth transistors T1, T2, T5, and T6 may be PMOS transistors. For example, the fifth and sixth transistors T5 and T6 may be PMOS transistors, and the first to fourth and seventh transistors T1 to T4 and T7 may be NMOS transistors. For example, the transistors T1 to T7 may all be NMOS transistors or may all be PMOS transistors.

As an example of the disclosure, the i-th gate lines GWLi, GCLi, GILi, GBLi, and EMLi may include a write scan line GWLi, a compensation scan line GCLi, an initialization scan line GILi, a black scan line GBLi, and a light emission control line EMLi. The number of scan lines and the number of light emission control lines included in the i-th gate lines GWLi, GCLi, GILi, GBLi, and EMLi are not necessarily limited thereto and may be variously modified. A write scan signal GWi is applied to the write scan line GWLi, a compensation scan signal GCi is applied to the compensation scan line GCLi, and an initialization scan signal GIi is applied to the initialization scan line GILi. A black scan signal GBi is applied to the black scan line GBLi, and a light emission control signal EMi is applied to the light emission control line EMLi.

The light-emitting element ED may include a light-emitting diode. The light emitting diode may include an organic light-emitting material, an inorganic light-emitting material, a quantum dot, a quantum rod, or the like as a light-emitting layer. The light-emitting element ED may include a first electrode (for example, an anode electrode) and a second electrode CE (for example, a cathode electrode). The first electrode of the light-emitting element ED may be connected to the first transistor T1 via the sixth transistor T6 to receive the driving current Id, and the second electrode CE may be connected to a second power supply line PL2 to receive the second driving voltage ELVSS. The light-emitting element ED may generate light having a luminance corresponding to the driving current Id. In an embodiment, the second electrode CE of the light-emitting element ED may be provided as a common electrode commonly connected to the pixels PX.

The first transistor T1 includes a first electrode connected to the first power supply line PL1 via a fifth transistor T5, a second electrode electrically connected to the first electrode of the light-emitting element ED via the sixth transistor T6, and a gate electrode connected to a first electrode CSE1 of the capacitor Cst. The first transistor T1 may receive the data voltage Dj transmitted by the j-th data line DLj according to the switching operation of the second transistor T2 to supply the driving current Id to the light-emitting element ED.

The second transistor T2 may include a first electrode connected to the j-th data line DLj, a second electrode connected to the first electrode of the first transistor T1, and a gate electrode connected to the write scan line GWLj. The second transistor T2 may be turned on in response to the write scan signal GWj received through the write scan line GWLj to provide the data voltage Dj transmitted from the j-th data line DLj to the first electrode of the first transistor T1.

The third transistor T3 may include a first electrode connected to the second electrode of the first transistor T1, a second electrode connected to the gate electrode of the first transistor T1, and a gate electrode connected to the compensation scan line GCLj. The third transistor T3 may be turned on in response to the compensation scan signal GCj received through the compensation scan line GCLj to diode-connect the first transistor T1. For example, the gate electrode and the second electrode of the first transistor T1 are connected to each other via the third transistor T3.

The fourth transistor T4 may include a first electrode connected to a gate electrode of the first transistor T1, a second electrode connected to a first initialization voltage line VL1 to which the first initialization voltage Vint is applied, and a gate electrode connected to the initialization scan line GILj. The fourth transistor T4 may be turned on in response to the initialization scan signal GIj received through the initialization scan line GILj and apply the first initialization voltage Vint to the gate electrode of the first transistor T1 to perform an initialization operation of initializing the potential of the gate electrode of first transistor T1.

The fifth transistor T5 may include a first electrode connected to the first power supply line PL1, a second electrode connected to a first electrode of the first transistor T1, and a gate electrode connected to the light emission control line EMLj.

The sixth transistor T6 may include a first electrode connected to the second electrode of the first transistor T1, a second electrode connected to the first electrode of the light-emitting element ED, and a gate electrode connected to the light emission control line EMLj.

The fifth transistor T5 and the sixth transistor T6 may be simultaneously turned on in response to the light emission control signal EMj received through the light emission control line EMLj. The first driving voltage ELVDD applied through the turned-on fifth transistor T5 may be compensated through the diode-connected first transistor T1 and then applied to the light-emitting element ED.

The seventh transistor T7 may include a first electrode connected to the second electrode of the sixth transistor T6, a second electrode connected to the second initialization voltage line VL2 to which the second initialization voltage Aint is applied, and a gate electrode connected to the black scan line GBLj. The seventh transistor T7 may be turned on in response to the black scan signal GBj received through the black scan line GBLj and apply the second initialization voltage Aint to the first electrode of the light-emitting element ED to perform an initialization operation of initializing the first electrode of a light-emitting element.

An end CSE1 of the capacitor Cst may be connected to the gate electrode of the first transistor T1 as described above, and another end CSE2 may be connected to the first power supply line PL1.

A specific operation of each pixel PX according to an embodiment is as follows.

During an initialization period, when the initialization scan signal GIj is supplied through the initialization scan line GILj, the first initialization transistor T4 is turned on in response to the initialization scan signals GIj. The first initialization voltage Vint may be applied to the gate electrode of the first transistor T1 through the turned-on first initialization transistor T4. For example, during the initialization period, the gate electrode of the first transistor T1 may be initialized to the first initialization voltage Vint.

During a compensation period, when the compensation scan signal GCi is supplied through the compensation scan line GCLi, the third transistor T3 is turned on in response to the compensation scan signal GCi. The first transistor T1 is diode-connected by the turned-on third transistor T3 and biased in the forward direction.

During a data write period, when the write scan signal GWi is supplied through the write scan line GWLi, the second transistor T2 is turned on in response to the write scan signal GWi. Then, a compensation voltage “Dj−Vth” reduced by the threshold voltage Vth of the first transistor T1 from the data voltage Dj supplied from the j-th data line DLj may be applied to the gate electrode of the first transistorT1. For example, the potential of the gate electrode of the first transistor T1 may be the compensation voltage “Dj-Vth”.

The first driving voltage ELVDD and the compensation voltage “Dj-Vth” are respectively applied to both ends of the storage capacitor Cst, and a charge corresponding to a voltage difference between the both ends of the storage capacitor Cst may be stored in the storage capacitor Cst.

During a black period, the seventh transistor T7 may be turned on by being supplied with the black scan signal GBj through the black scan line GBLj. The driving current Id may exit through the seventh transistor T7 as the bypass current Ibp, and as a result, the anode of the light-emitting element ED may be initialized.

Next, when the fifth transistor T5 and the sixth transistor T6 are turned on by the light emission control signal EMj supplied from the light emission control line EMLj, the driving current Id corresponding to a voltage difference between the gate voltage of the gate electrode of the first transistor T1 and the first driving voltage ELVDD may be generated. Therefore, the driving current Id may be supplied to the light-emitting element ED through the sixth transistor T6, so that the light-emitting device ED can emit light.

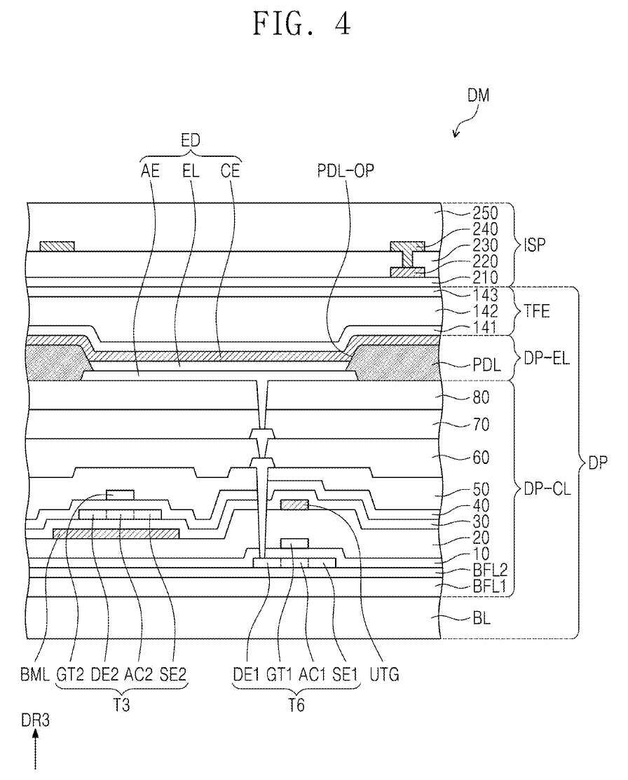

FIG. 4 is a cross-sectional view showing a partial area of the display module shown in FIG. 1C.

Referring to FIG. 4, the display module DM may include a display panel DP and an input sensing layer ISP disposed on (e.g., ‘directly on’) the display panel DP. The display panel DP may include a base layer BL, a circuit element layer DP-CL, a light-emitting element layer DP-EL, and an encapsulation layer TFE.

The base layer BL may provide a base surface on which the circuit element layer DP-CL may be disposed. The circuit element layer DP-CL may be disposed on the base layer BL. The circuit element layer DP-CL may include an insulating layer, a semiconductor pattern, a conductive pattern, a signal line, and the like. An insulating layer, a semiconductor layer, and a conductive layer are formed over the base layer BL by coating, vapor deposition, or the like, and then the insulating layer, the semiconductor layer, and the conductive layer may be selectively patterned through multiple photolithography processes. Thereafter, the semiconductor pattern, the conductive pattern, and the signal line included in the circuit element layer DP-CL may be formed.

At least one inorganic layer may be formed on the upper surface of the base layer BL. In this embodiment, the display panel DP is shown to include two buffer layers BFL1 and BFL2 (for example, ‘first and second buffer layers’). The first and second buffer layers BFL1 and BFL2 may improve a coupling force between the base layer BL and the semiconductor pattern. The first and second buffer layers BFL1 and BFL2 may include silicon oxide layers and silicon nitride layers, and the silicon oxide layers and the silicon nitride layers may be alternately stacked on each other.

A first semiconductor pattern may be disposed over the second buffer layer BFL2. The first semiconductor pattern may comprise polysilicon. However, an embodiment of the disclosure is not necessarily limited thereto, the first semiconductor pattern may include amorphous silicon or a metal oxide.

FIG. 4 illustrates some first semiconductor patterns, and the first semiconductor patterns may be further disposed in other areas. The first semiconductor pattern may be arranged in a particular pattern across the pixels. The first semiconductor pattern may have different electrical properties depending on whether it is doped or not. The first semiconductor pattern may include a first region having a high conductivity and a second region having a low conductivity. The first region may be doped with an N-type dopant or a P-type dopant. A P-type transistor may include a doped region doped with the P-type dopant. The second region may be a non-doped region or may be doped at a lower concentration than the first region.

The conductivity of the first region is greater than the second region and substantially serves as an electrode or a signal line. The second region may substantially correspond to an activation region (or channel region) of the transistor. For example, a portion of the first semiconductor pattern may be the channel region of the transistor, and another portion of the first semiconductor pattern may be a source region or a drain region of the transistor.

FIG. 4 exemplarily illustrates the third transistor T3 and the sixth transistor T6 of the pixel driving circuit PDC (see FIG. 3), and the light-emitting element ED.

A source region SE1, a channel region AC1, and a drain region DE1 of the sixth transistor T6 may be formed from the first semiconductor pattern. The source region SE1 and the drain region DE1 may extend in opposite directions from the channel region AC1 on a cross-section.

A first insulating layer 10 may be disposed over the second buffer layer BFL2. The first insulating layer 10 may commonly overlap multiple pixels and cover the first semiconductor pattern. The first insulating layer 10 may be an inorganic layer and/or an organic layer, and may have a single-layer structure or a multi-layer structure. The first insulating layer 10 may include at least one of aluminum oxide, titanium oxide, silicon oxide, silicon nitride, silicon oxy nitride, zirconium oxide, and hafnium oxide. In this embodiment, the first insulating layer 10 may be a single-layer silicon oxide layer. Each of the insulating layers of the circuit element layer DP-CL described later as well as the first insulating layer 10 may be an inorganic layer and/or an organic layer, and may have a single-layer structure or a multi-layer structure. The inorganic layer may include at least one of the materials described above, but embodiments of the disclosure are not necessarily limited thereto.

A gate electrode GT1 of the sixth transistor T6 is disposed over the first insulating layer 10. The gate electrode GT1 may be a portion of a metal pattern. The gate electrode GT1 of the sixth transistor T6 may overlap the channel region AC1 of the sixth transistor T6. In the process of doping the first semiconductor pattern, the gate electrode GT1 of the sixth transistor T6 may function as a mask.

A second insulating layer 20 may be disposed over the first insulating layer 10 and may cover the gate electrode GT1. The second insulating layer 20 may overlap the pixels in common. The second insulating layer 20 may be an inorganic layer and/or an organic layer, and may have a single-layer structure or a multi-layer structure. In this embodiment, the second insulating layer 20 may be a single-layer silicon oxide layer.

An upper gate electrode UGT of the sixth transistor T6 may be disposed over the second insulating layer 20. The upper gate electrode UGT may be a portion of a metal pattern. The upper gate electrode UGT may overlap the gate electrode GT1 of the sixth transistor T6.

A third insulating layer 30 may be disposed over the second insulating layer 20. The third insulating layer 30 may overlap multiple pixels in common and cover the upper gate electrode UGT. The third insulating layer 30 may have a single-layer structure or a multi-layer structure. For example, the third insulating layer 30 may have a multilayer structure including a silicon oxide layer and a silicon nitride layer. A lower metal layer BML may be disposed between the second insulating layer 20 and the third insulating layer 30. The bottom metal layer BML may receive a constant voltage or a signal. The lower metal layer BML and the upper gate electrode UGT of the sixth transistor T6 may be disposed on a same layer.

A second semiconductor pattern may be disposed over the third insulating layer 30. The second semiconductor pattern may include an oxide semiconductor. The oxide semiconductor may include multiple regions that are distinguished according to whether or not the metal oxide is reduced. A region in which the metal oxide is reduced (hereinafter, ‘a reduction region’) has higher conductivity than a region in which the metal oxide is not reduced (hereinafter, ‘a non-reduction region’). The reduction region substantially serves as a source region/drain region of the transistor or signal line. The non-reduction region substantially corresponds to an activation region (or ‘a channel region’) of the transistor. For example, a portion of the second semiconductor pattern may be the channel region of the transistor, another portion of the second semiconductor pattern may be a source region/drain region of the transistor, and another portion of the second semiconductor pattern may be the signal transfer region.

A source region SE2, a channel region AC2, and a drain region DE2 of the third transistor T3 may be formed from the second semiconductor pattern. The source region SE2 and the drain region DE2 may extend in opposite directions from the channel region AC2 on a cross-section.

A fourth insulating layer 40 may be disposed over the third insulating layer 30. The fourth insulating layer 40 may commonly overlap the pixels and cover the second semiconductor pattern. The fourth insulating layer 40 may include at least one of aluminum oxide, titanium oxide, silicon oxide, silicon nitride, silicon oxy nitride, zirconium oxide, and hafnium oxide.

A gate electrode GT2 of the third transistor T3 is disposed over the fourth insulating layer 40. The gate electrode GT2 may be a portion of a metal pattern. The gate electrode GT2 of the third transistor T3 may overlap the channel region AC2 of the third transistor T3. In the process of doping the second semiconductor pattern, the gate electrode GT2 of the third transistor T3 may function as a mask.

A fifth insulating layer 50 may be disposed over the fourth insulating layer 40 and may cover the gate electrode GT2. The fifth insulating layer 50 may be an inorganic layer and/or an organic layer, and may have a single-layer structure or a multi-layer structure.

A first connection electrode CNE1 may be disposed over the fifth insulating layer 50. The first connection electrode CNE1 may be connected to the drain region DE1 of the sixth transistor T6 through a contact hole penetrating the first to fifth insulating layers 10, 20, 30, 40, and 50.

A sixth insulating layer 60 may be disposed over the fifth insulating layer 50. A second connection electrode CNE2 may be disposed over the sixth insulating layer 60. The second connection electrode CNE2 may be connected to the first connection electrode CNE1 through a contact hole penetrating the sixth insulating layer 60.

A seventh insulating layer 70 is disposed over the sixth insulating layer 60, and may cover the second connection electrode CNE2. An eighth insulating layer 80 may be disposed over the seventh insulating layer 70.

Each of the sixth insulating layer 60, the seventh insulating layer 70, and the eighth insulating layer 80 may be an organic layer. For example, each of the sixth insulating layer 60, the seventh insulating layer 70, and the eighth insulating layer 80 may include general-purpose polymers such as BCB (Benzocyclobutene), polyimide, HMDSO (Hexamethyldisiloxane), Polymethylmethacrylate (PMMA), and Polystyrene (PS), polymer derivatives having a phenolic group, acrylic polymers, imide polymers, aryl ether polymers, amide polymers, fluorine polymers, p-xylene polymers, vinyl alcohol polymers, blends thereof, the like, or a combination thereof.

The light-emitting element layer DP-EL including the light-emitting element ED may be disposed over the circuit element layer DP-CL. The light-emitting element ED may include a first electrode AE, a light-emitting layer EL, and a second electrode CE. The second electrode CE may be connected to the pixels PX (see FIG. 2) and may be provided in common.

The first electrode AE may be disposed over the eighth insulating layer 80. The first electrode AE may be a (semi-)transmissive electrode or a reflective electrode. In an embodiment, the first electrode AE may include a reflective layer formed of Ag, Mg, Al, Pt, Pd, Au, Ni, Nd, Ir, Cr, a compound thereof, the like, or a combination thereof, and a transparent or translucent electrode layer formed on the reflective layer. The transparent or translucent electrode layer may include at least one selected from the group including indium tin oxide (ITO), indium zinc oxide (IZO), indium gallium zinc oxide (IGZO), zinc oxide (ZnO) or indium oxide (In₂O₃), and aluminum doped zinc oxide (AZO). For example, the first electrode AE may be provided with ITO/Ag/ITO.

A pixel defining layer PDL may be disposed over the eighth insulating layer 80. The pixel defining layer PDL may have a property of absorbing light, and for example, the pixel defining layer PDL may have a black color. The pixel defining layer PDL may include a black coloring agent. The black coloring agent may comprise a black dye, a black pigment. The black coloring agent may comprise a metal such as carbon black, chromium, an oxide thereof, or a combination thereof.

The pixel defining layer PDL may cover a portion of the first electrode AE. For example, a pixel opening PDL-OP exposing a portion of the first electrode AE may be defined in the pixel defining layer PDL. An area overlapping the pixel opening PDL-OP in the display panel DP in a plan view may be defined as a light emitting area EA, and the remaining area may be defined as a non-light emitting area NEA. The light-emitting element ED may be provided corresponding to the light-emitting area EA.

The light-emitting layer EL may be disposed on the first electrode AE. In this embodiment, the light-emitting layer EL typically may output light of at least one color of blue, red, and green.

The second electrode CE may be disposed on the light-emitting layer EL. The second electrode CE may be commonly formed in the pixels PX (see FIG. 2) using an open mask.

A hole control layer may be disposed between the first electrode AE and the light-emitting layer EL. The hole control layer may include a hole transport layer, and may further include a hole injection layer. An electronic control layer may be disposed between the light-emitting layer EL and the second electrode CE. The electron control layer may include an electron transport layer, and may further include an electron injection layer. The hole control layer and the electron control layer may be commonly formed in the pixels PX using an open mask.

The encapsulation layer TFE may be disposed on the light-emitting element layer DP-EL. The encapsulation layer TFE may include a first inorganic layer 141, an organic layer 142, and a second inorganic layer 143 sequentially stacked on each other, but the layers constituting the encapsulation layer TFE are not necessarily limited thereto.

The first and second inorganic layers 141 and 143 may protect the light-emitting element layer DP-EL from moisture and oxygen, and the organic layer 142 may protect the light-emitting element layer DP-EL from foreign material such as dust particles. The first and second inorganic layers 141 and 143 may include a silicon nitride layer, a silicon oxy nitride layer, a silicon oxide layer, a titanium oxide layer, an aluminum oxide layer, the like, or a combination thereof. The organic layer 142 may include an acrylic-based organic layer, but embodiments of the disclosure are not necessarily limited thereto.

The input sensing layer ISP may be disposed on the display panel DP. The input sensing layer ISP may also be referred to as an input sensor or an input sensing panel. The input sensing layer ISP may include an insulating base layer 210, a first conductive layer 220, an intermediate insulating layer 230, a second conductive layer 240, and a protective layer 250.

The insulating base layer 210 may be disposed on (e.g., ‘directly on’) the display panel DP. The insulating base layer 210 may be an inorganic layer including at least any one of silicon nitride, silicon oxy nitride, and silicon oxide. As another example, the insulating base layer 210 may be an organic layer containing an epoxy resin, an acrylic resin, an imide-based resin, or a combination thereof. The insulating base layer 210 may have a single-layer structure or a multi-layer structure stacked on each other in the third direction DR3.

Each of the first conductive layer 220 and the second conductive layer 240 may have a single-layer structure or a multi-layer structure stacked on each other in the third direction DR3.

The conductive layer having the single-layer structure may include a metal layer or a transparent conductive layer. The metal layer may comprise molybdenum, silver, titanium, copper, aluminum, an alloy thereof, or a combination thereof. The transparent conductive layer may include a transparent conductive oxide such as indium tin oxide (ITO), indium zinc oxide (IZO), zinc oxide (ZnO), indium zinc tin oxide (ISTO), or a combination thereof. The transparent conductive layer may include a conductive polymer such as PEDOT, a metal nanowire, graphene, or the like.

The conductive layer of the multi-layer structure may include metal layers. The metal layers may have, for example, a three-layer structure of titanium/aluminum/titanium. The conductive layer of the multi-layer structure may include at least one metal layer and at least one transparent conductive layer.

The intermediate insulating layer 230 may be disposed between the first conductive layer 220 and the second conductive layer 240, and the protective layer 250 may cover the second conductive layer 240 and the intermediate insulating layer 230. Each of the intermediate insulating layer 230 and the protective layer 250 may include an inorganic layer. The inorganic layer may include at least one of aluminum oxide, titanium oxide, silicon oxide, silicon nitride, silicon oxy nitride, zirconium oxide, and hafnium oxide. As another example, the intermediate insulating layer 230 and the protective layer 250 may include an organic layer. The organic layer may include at least one of an acrylic resin, a methacrylic resin, polyisoprene, a vinyl resin, an epoxy resin, a urethane resin, a cellulose resin, a siloxane resin, a polyimide resin, a polyamide resin, and a perylene resin.

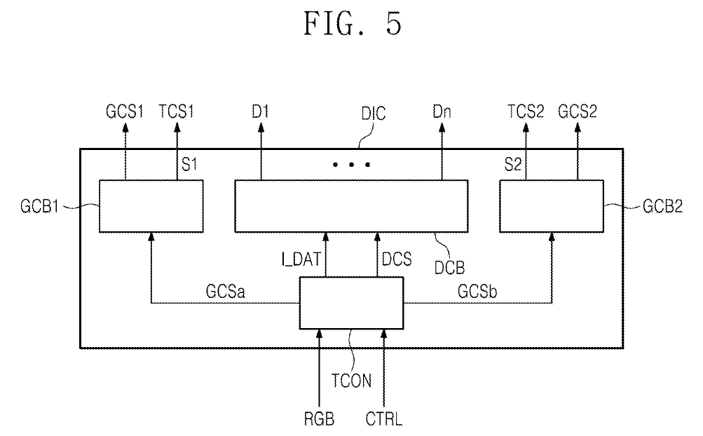

FIG. 5 is a block diagram illustrating a driving chip according to an embodiment of the disclosure.

Referring to FIG. 5, the driving chip DIC may include a driving control circuit TCON, first and second gate control circuits GCB1 and GCB2, and a data driving circuit DCB.

The driving control circuit TCON may receive the input image signal RGB and the control signal CTRL from the host processor. As an example of the disclosure, the host processor may be a graphics processing unit (GPU). The driving control circuit TCON may convert the data format of the input image signal RGB to generate the image data I_DAT, and may provide the generated image data I_ DAT to the data driving circuit DCB. The control signal CTRL may include a vertical synchronization signal, a data enable signal, a master clock signal, or the like. The driving control circuit TCON may generate first and second pre-gate control signals GCSa and GCSb and a data control signal DCS based on the control signal CTRL.

The data driving circuit DCB may receive the data control signal DCS and the image data I_DAT from the driving control circuit TCON. The data driving circuit DCB may convert the image data I_DAT into data voltages D1 to Dn, and may output the data voltages D1 to Dn to the data lines DL1 to DLn (see FIG. 2). The data voltages D1 to Dn may be analog voltages corresponding to the grayscale value of the image data I_DAT. Here, n is an integer of 1 or more.

The first and second gate control circuits GCB1 and GCB2 may receive the first and second pre-gate control signals GCSa and GCSb from the driving control circuit TCON, and shift the levels of the first and second pre-gate control signals GCSa and GCSb to generate first and second gate control signals GCS1 and GCS2. For example, in the first and second gate control circuits GCB1 and GCB2, the first and second pre-gate control signals GCSa and GCSb may be shifted to levels appropriate for driving the first and second gate driving circuits GDC1 and GDC2 (see FIG. 2) embedded in the display panel DP (see FIG. 2-2).

As an example of the disclosure, the driving chip DIC may output a switching signal that is activated in the test mode. The switching signal may include a first switching signal TCS1 applied to the first switching circuit MSC1 (see FIG. 2) and a second switching signal TCS2 applied to the second switching circuit MSC2 (see FIG. 2). The driving chip DIC may output the first and second switching signals TCS1 and TCS2, respectively, through the first and second dummy terminals S1 and S2, respectively. As an example of the disclosure, the first and second gate control circuits GCB1 and GCB2 may output the first and second switching signals TCS1 and TCS2, respectively, and in this case, the first and the second dummy terminals S1 and S2, respectively, may be connected to the first and second gate control circuits GCB1 and GCB2, respectively.

As shown in FIG. 2, the first gate control circuit GCB1 may be connected to the first gate driving circuit GDC1 through the first control line CSL1, and the second gate control circuit GCB2 may be connected to the second gate driving circuit GDC2 through the second control line CSL2. Therefore, the first gate control signal GCS1 output from the first gate control circuit GCB1 may be applied to the first gate driving circuit GDC1 through the first control line CSL1, and the second gate control signal GCS2 output from the second gate control circuit GCB2 may be applied to the second gate driving circuit GDC2 through the second control line CSL2. The first and second dummy terminals S1 and S2, respectively, may be selected from among terminals remaining without being connected to the first and second control lines CSL1 and CSL2.

As an example of the disclosure, the first gate control signal GCS1 may include a start signal, a clock signal, first and second gate driving voltages, and the like. The first gate driving voltage may be a gate high voltage and the second gate driving voltage may be a gate low voltage having a lower voltage level than the first gate driving voltage.

The first and second switching circuits MSC1 and MSC2 may be connected to the driving chip DIC, and may be activated in the test mode in response to the first and second switching signals TCS1 and TCS2, respectively, provided from the driving chip DIC.

The first gate control circuit GCB1 may output the first or second gate driving voltage as the first switching signal TCS1 according to a mode. For example, the first gate control circuit GCB1 may output the first gate driving voltage as the first switching signal TCS1 in the normal mode, and output the second gate driving voltage as the first switching signal TSC1 in the test mode. The second gate control circuit GCB2 may output the first or second gate driving voltage as the second switching signal TCS2 according to a mode. For example, the second gate control circuit GCB2 may output the first gate driving voltage as the second switching signal TCS2 in the normal mode, and output the second gate driving voltage as the second switching signal TSC2 in the test mode.

FIG. 5 illustrates a structure in which the first and second switching signals TCS1 and TCS2 are output from the first and second gate control circuits GCB1 and GCB2, but embodiments of the disclosure are not necessarily limited thereto. As another example, the first and second switching signals TCS1 and TCS2 may be output from the data driving circuit DCB, or a separate circuit for outputting the first and second switch signals TCS1 or TCS2 may be embedded in the driving chip DIC.

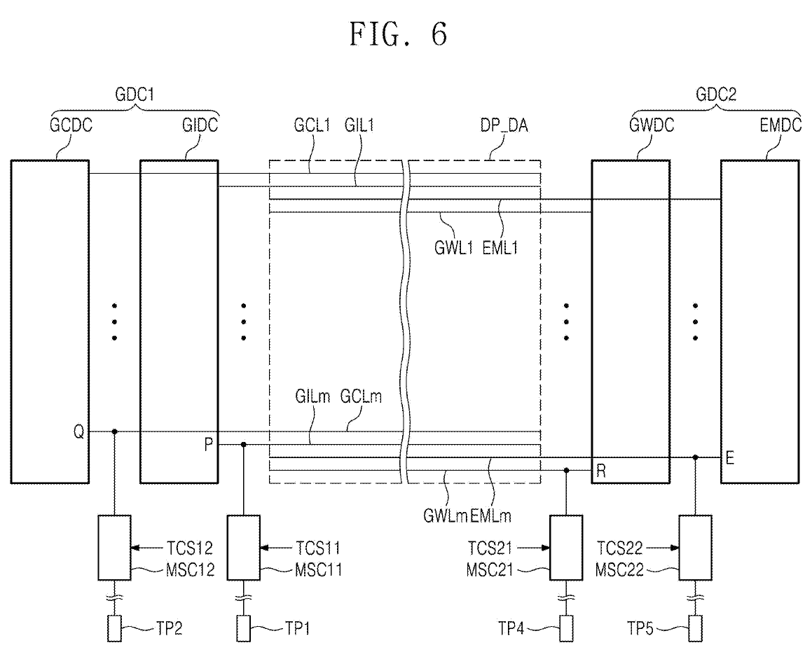

FIG. 6 is a block diagram illustrating a connection relationship between the first and second gate driving circuits and the test pad according to an embodiment of the disclosure.

Referring to FIG. 6, the first gate driving circuit GDC1 may be disposed adjacent to a first side of the display area DP_DA, and the second gate driving circuit GDC2 may be disposed adjacent to a second side opposite to the first side of the display area DP_DA. As an example of the disclosure, the first gate driving circuit GDC1 may include a first scan driving circuit GIDC and a second scan driving circuit GCDC, and the second gate driving circuit GDC2 may include a third scan driving circuit GWDC and a light emission driving circuit EMDC.

The first scan driving circuit GIDC may be connected to initialization scan lines GIL1 to GILm, and may supply initialization scan signals to the initialization scan lines GIL1 to GILm. The second scan driving circuit GCDC may be connected to compensation scan lines GCL1 to GCLm, and may supply compensation scan signals to the compensation scan line GCL1 to GCLm. The third scan driving circuit GWDC may be connected to write scan lines GWL1 to GWLm, and may supply write scan signals to the write scan line GWL1 to GWLm. The light emission driving circuit EMDC may be connected to the light emission control lines EML1 to EMLm, and may supply light-emitting control signals to the light emission control lines EML1 to EMLm.

FIG. 6 illustrates a structure in which two driving circuits are included in each of the first and second gate driving circuits GDC1 and GDC2, but embodiments of the disclosure are not necessarily limited thereto. As another example, three or four driving circuits may be included in each of the first and second gate driving circuits GDC1 and GDC2, or one driving circuit may be included in each of the first and second gate driving circuits GDC1 and GDC2.

When two driving circuits are included in each of the first and second gate driving circuits GDC1 and GDC2, two switching circuits may be respectively connected to the two driving circuits to respectively inspect the two driving circuits. Here, a switching circuit connected to the first scan driving circuit GIDC is referred to as a first-first switching circuit MSC11, and a switching circuit connected with the second scan driving circuit GCDC is referred to a first-second switching circuit MSC12. A switching circuit connected to the third scan driving circuit GWDC is referred to as a second-first switching circuit MSC21, and a switching circuit connected to a light emission driving circuit EMDC is referred to a second-second switching circuit MSC22. The first-first, first-second, and second-first switching circuits MSC11, MSC12, and MSC21 may be referred to as a first sub-switching circuit, and the second-second switching circuit MSC22 may be referred to a second sub-switching circuit.

The first-first switching circuit MSC11 may be connected between the first scan driving circuit GIDC and the first test pad TP1, and may receive a first-first switching signal TCS11 from the driving chip DIC (see FIG. 5 ). The first-first switching circuit MSC11 may electrically connect the first test pad TP1 and the m-th output terminal P of the first scan driving circuit GIDC connected to the m-th initialization scan line GILm in a test mode in which the first-first switching signal TCS11 is activated.

The first-second switching circuit MSC12 may be connected between the second scan driving circuit GCDC and the second test pad TP2, and may receive a first-second switching signal TSC12 from the driving chip DIC. The first-second switching circuit MSC12 may electrically connect the second test pad TP2 and the m-th output terminal Q of the second scan driving circuit GCDC connected to the m-th compensation scan line GCLm in the test mode in which the first-second switching signal TCS12 is activated.

The second-first switching circuit MSC21 may be connected between the third scan driving circuit GWDC and the fourth test pad TP4, and may receive second-first switching signal TCS21 from the driving chip DIC (see FIG. 5 ). The second-first switching circuit MSC21 may electrically connect the fourth test pad TP4 and the m-th output terminal R of the third scan driving circuit GWDC connected to the m-th write scan line GWLm in the test mode in which the second-first switching signal TCS21 is activated.

The second-second switching circuit MSC22 may be connected between the light emission driving circuit EMDC and the fifth test pad TP5, and may receive the second-second switching signal TSC22 from the driving chip DIC. The second-second switching circuit MSC22 may electrically connect the fifth test pad TP5 and the m-th output terminal E of the light emission driving circuit EMDC connected to the m-th light emission control line EMLm in the test mode in which the second-second switching signal TCS22 is activated.

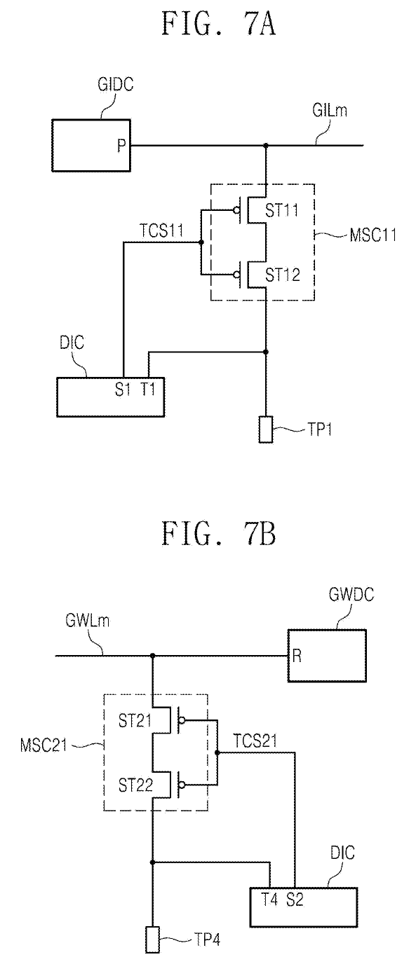

FIG. 7A is a diagram illustrating a connection between the first scan driving circuit and the first-first switching circuit illustrated in FIGS. 6 and 7B, and is a diagram illustrating the connection between the third scan driving circuit and the second-first switching circuit illustrated in FIG. 6.

Referring to FIG. 7A, the first-first switching circuit MSC11 may include one or more switching transistors connected between the m-th output terminal P (i.e., the m-th initialization scan line GILm) of the first scan driving circuit GIDC and the first test pad TP1. FIG. 7A illustrates a structure in which the first-first switching circuit MSC11 includes two switching transistors, but embodiments of the disclosure are not necessarily limited thereto. As another example, the first-first switching circuit MSC11 may include one switching transistor or three switching transistors. When the number of switching transistors increases, the effect of blocking current leakage to the first test pad TP1 in the normal mode in which the test mode is not operated may be improved, but the area occupied by the first-first switching circuit MSC11 may increase.

The two switching transistors included in the first-first switching circuit MSC11 in FIG. 7A may be referred to as a first-first switching transistor ST11 and a first-second switching transistor ST12, respectively. The first-first switching transistor ST11 may include a first electrode connected to the m-th initialization scan line GILm, a second electrode connected to the first-second switching transistor ST12, and a control electrode connected to the driving chip DIC. The first-second switching transistor ST12 may include a first electrode connected to the first-first switching transistor ST11, a second electrode connected to the first test pad TP1, and a control electrode connected to the driving chip DIC. The control electrode of the first-first switching transistor ST11 and the control electrode of the first-second switching transistor ST12 may be commonly connected to the first dummy terminal S1 of the driving chip DIC to commonly receive the first-first switching signal TCS11.

The first test pad TP1 may be connected to a test terminal T1 of the driving chip DIC. Therefore, the first test pad TP1 may also be utilized to inspect the driving chip DIC. However, when the first test pad TP1 is utilized to inspect the first scan driving circuit GIDC, since the test terminal T1 is in a state of not outputting any signal, the output (i.e., the m-th initialization scan signal) of the first scan driving circuit GIDC may be realized at in the first test pad TP1.

In the test mode, the first scan driving circuit GIDC may perform a test operation of outputting the initialization scan signals to the initialization scan lines GIL1 to GILm (see FIG. 6 ). When the first-first switching signal TCS11 is activated in the test mode, the first and second switching transistors ST11 and ST12 are turned on, and the m-th initialization scan signal applied to the m-th initializing scan line GILm may be provided to the first test pad TP1 through the turned-on first and second switching transistors ST11 and ST12. An inspection device may analyze the m-th initialization scan signal output from the first test pad TP1 to inspect whether the first scan driving circuit GIDC is defective.

The two switching transistors included in the second-first switching circuit MSC21 in FIG. 7B may be referred to as a second-first switching transistor ST21 and a second-second switching transistor ST22, respectively. The second-first switching transistor ST21 may include a first electrode connected to the m-th write scan line GWLm, a second electrode connected to the second-second switching transistor ST22, and a control electrode connected to the driving chip DIC. The second-second switching transistor ST22 may include a first electrode connected to the second-first switching transistor ST21, a second electrode connected to the fourth test pad TP4, and a control electrode connected to the driving chip DIC. The control electrode of the second-first switching transistor ST21 and the control electrode of the second-second switching transistor ST22 may be commonly connected to the second dummy terminal S2 of the driving chip DIC to commonly receive the second-first switching signal TCS21.

The fourth test pad TP4 may be connected to a test terminal T4 of the driving chip DIC. Therefore, the fourth test pad TP4 may also be utilized to inspect the driving chip DIC. However, when the fourth test pad TP4 is utilized to inspect the third scan driving circuit GWDC, since the test terminal T4 is in a state of not outputting any signal, only the output (for example, the m-th write scan signal) of the third scan driving circuit GWDC may be realized at the fourth test pad TP4.

In the test mode, the third scan driving circuit GWDC may perform a test operation of outputting write scan signals to the write scan lines GWL1 to GWLm (see FIG. 6 ). When the second-first switching signal TCS21 is activated in the test mode, the second-first and second-second switching transistors ST21 and ST22 may be turned on, and the m-th write scan signal applied to the m-th writing scan line GWLm may be provided to the fourth test pad TP4 through the turned-on second-first and second-second switching transistors ST21 and ST22. The inspection device may analyze the m-th write scan signal output from the fourth test pad TP4 to inspect whether the third scan driving circuit GWDC is defective.

To the extent that the connection of the first-second switching circuit MSC12, the second scan driving circuit GCDC, and the second test pad TP2 is not described in detail in this disclosure, it may be understood that the connection of the first-second switching circuit MSC12, the second scan driving circuit GCDC, and the second test pad TP2 is at least similar to the connection of the first-first switching circuit MSC11, the first scan driving circuit GIDC, and the first test pad TP1 that has been described in FIG. 7A within this disclosure. To the extent that the configuration of the first-second switching circuit MSC12 is not described in detail in this disclosure, it may be understood that the configuration of the first-second switching circuit MSC12 is at least similar to the configuration of the first-first switching circuit MSC11 described in conjunction with FIG. 7A .

Similarly, to the extent that the connection of the second-second switching circuit MSC22, the light emission driving circuit EMDC, and the fifth test pad TP5 is not described in detail in this disclosure, it may be understood that the connection of the second-second switching circuit MSC22, the light emission driving circuit EMDC, and the fifth test pad TP5 is at least similar to the connection of the second-first switching circuit MSC21, the third scan driving circuit GWDC, and the fourth test pad TP4 that has been described in FIG. 7BB of this disclosure. To the extent that the configuration of the second-second switching circuit MSC22 is not described in detail in this disclosure, it may be understood that the configuration of the second-second switching circuit MSC22 may be similar to the configuration of the second-first switching circuit MSC21 that has been described in FIG. 7B of this disclosure.

According to embodiments of the disclosure, there is provided a design for display device DD and an electronic device EA that includes the same that can readily inspect a gate driving circuit. The display device may operate in a normal mode where an image is displayed and in a test mode where a gate signal supplied by a gate driving circuit is inspected. Switching circuits MSC are included that connect a gate line connected to an output port of the gate driver to a test pad TPD. The display device may also include a driving chip DIC that serves as a data driver, supplies a gate control signal GCS to control the gate driving circuits GDC, and supplies switching signals TSC to the switching circuits to allow for transmission of the gate signal to a test pad for inspection. The gate signal transmitted to the test pad may be from a same gate line that is used to deliver scan signals to pixels in a normal mode, or may be from a dummy line dedicated to inspection of the gate signals to avoid load variations in gate lines.

The switching circuit MSC can take various forms, but is generally a pair of transistors connected in series between the gate line and the test pad. In test mode, the switching signals may be activated to turn on the switching circuit so that the sampled gate line may be connected to the test pad to allow for inspection of the gate signal. During normal mode, the switching signal TSC may be deactivated to electrically disconnect the gate line from the test pad. As a result, gate signals may be transmitted to the test pad for inspection in a manner that minimizes interference with the normal display operation of the display panel.

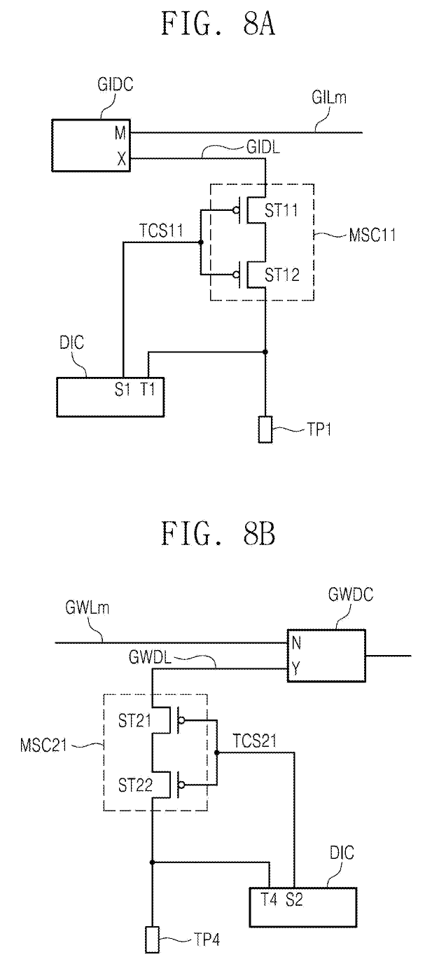

FIG. 8A is a diagram illustrating a connection between a first scan driving circuit and a first-first switching circuit according to an embodiment of the disclosure, and FIG. 8B is a diagram illustrating the connection between a third scan driving circuit and a second-first switching circuit according the embodiment of the disclosure. To the extent that an element is not described in detail with respect to FIGS. 8A and 8B, it may be understood that the element is at least similar to a corresponding element that has been described previously within the present disclosure.

Referring to FIG. 8A, the first-first switching circuit MSC11 may include one or more switching transistors connected between a dummy output terminal X (for example, a dummy initialization scan line GIDL) of the first scan driving circuit GIDC and the first test pad TP1. The dummy initialization scan line GIDL may receive an (m+1)-th initialization scan signal from the first scan driving circuit GIDC. The dummy initialization scan line GIDL might not be connected to the pixels PX (see FIG. 2), and may be merely a line provided for connecting the first scan driving circuit GIDC and the first-first switching circuit MSC11.

When the first-first switching circuit MSC11 is connected to the m-th initialization scan line GILm as shown in FIG. 7A, a load of the m-th initialization scan line GILm may increase, and thus luminance differences may occur between pixels connected to the m-th initialization scan lines GILm and pixels connected to remaining initialization scan lines. However, when the first-first switching circuit MSC11 is connected to the dummy initialization scan line GIDL that is not connected to a pixel as shown in FIG. 8A, it is possible to prevent luminance differences from occurring between the pixels connected to the m-th initialization scan line GILm and the pixels connected to the remaining initialization scan lines.

Referring to FIG. 8B, the second-first switching circuit MSC21 may include one or more switching transistors connected between the dummy output terminal Y (for example, the dummy write scan line GWDL) of the third scan driving circuit GWDC and the fourth test pad TP4. The dummy write scan line GWDL may receive the (m+1)-th write scan signal from the third scan driving circuit GWDC. The dummy write scan line GWDL might not be connected to the pixels PX (see FIG. 2), and may be merely a line provided for connecting the third scan driving circuit GWDC and the second-first switching circuit MSC21.

When the second-first switching circuit MSC21 is connected to the m-th write scan line GWLm as shown in FIG. 7B, a load of the m-th writing scan line GWLm may increase, and thus luminance differences may occur between pixels connected to the m-th write scan line GWLm and pixels connected to remaining write scan lines. However, when the second-first switching circuit MSC21 is connected to the dummy write scan line GWDL that is not connected to a pixel as shown in FIG. 8B, it is possible to prevent luminance differences from occurring between pixels connected to the m-th write scan line GWLm and pixels connected to remaining write scan lines.

Each of the first-first and first-second switching transistors ST11 and ST12 in FIGS. 7A and 8A may be a PMOS transistor. Accordingly, the first-first switching signal TCS11 applied to the first-first and the first-second switching transistors ST11 and ST12 may have a low level (i.e., ‘an activation level’) in the test mode and have a high level (i.e., ‘a deactivation level’) in the normal mode. However, embodiments of the disclosure are not necessarily limited thereto. As an example, each of the first-first and first-second switching transistors ST11 and ST12 may be an NMOS transistor, or one of the first-first or first-second switching transistor ST11 or ST12 may be an NMOS transistor and another may be a PMOS transistor.

Each of the second-first and second-second switching transistors ST21 and ST22 in FIGS. 7B and 8B may be a PMOS transistor. Accordingly, the second-first switching signal TCS21 applied to the second-first and second-second switching transistors ST21 and ST22 may have a low level (i.e., ‘an activation level’) in the test mode and have a high level (i.e., ‘a deactivation level’) in the normal mode. However, embodiments of the disclosure are not necessarily limited thereto. As an example, each of the second-first and second-second switching transistors ST21 and ST22 may be an NMOS transistor, or one of the second-first or second-second switching transistor ST21 or ST22 may be an NMOS transistor and another may be a PMOS transistor.

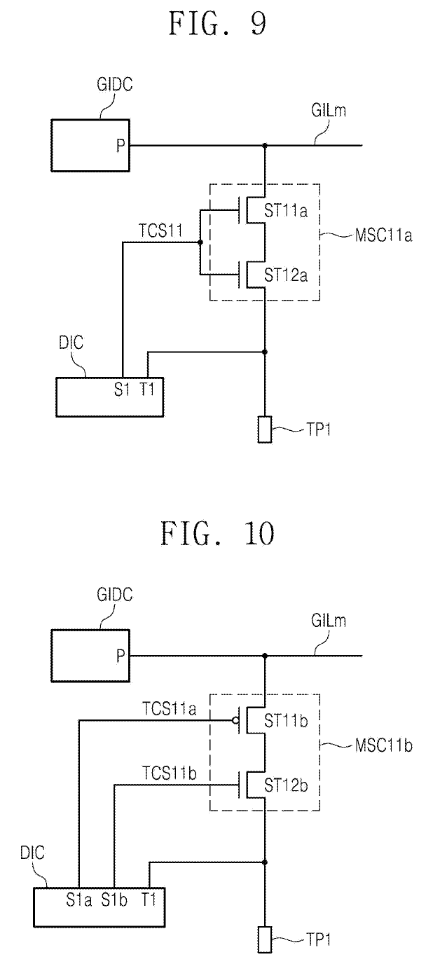

FIGS. 9 and 10 are diagrams illustrating an internal configuration of a first-first switching circuit according to embodiments of the disclosure. To the extent that the first-second, second-first, and second-second switching circuits MSC12, MSC21, and MSC22 (see FIG. 6) are not described in detail with respect to these figures, it may be understood that the first-second, second-first, and second-second switching circuits MSC12, MSC21, and MSC22 are at least similar to the first-first switching circuits MSC11a and MSC11b that have been described in conjunction with FIGS. 9-10.

Referring to FIG. 9,two switching transistors included in the first-first switching circuit MSC11a may be referred to as a first-first switching transistor ST11a and a first-second switching transistor ST12a, respectively. The first-first switching transistor ST11a may include a first electrode connected to the m-th initialization scan line GILm, a second electrode connected to the first-second switching transistor ST12a, and a control electrode connected to the driving chip DIC. The first-second switching transistor ST12a may include a first electrode connected to the first-first switching transistor ST11a, a second electrode connected to the first test pad TP1, and a control electrode connected to the driving chip DIC. The control electrode of the first-first switching transistor ST11a and the control electrode of the first-second switching transistor ST12a may be commonly connected to the first dummy terminal S1 of the driving chip DIC to commonly receive the first-first switching signal TCS11.

Each of the first-first switching transistor ST11a and the first-second switching transistor ST12a may be an NMOS transistor. Accordingly, the first-first switching signal TCS11 applied to the first-first and first-second switching transistors ST11a and ST12a may have a high level (i.e., ‘a high level activation level’) in the test mode and have a low level (i.e., a low level deactivation level’) in the normal mode.

Referring to FIG. 10, two switching transistors included in the first-first switching circuit MSC11b may be referred to as a first-first switching transistor ST11b and a first-second switching transistor ST12b, respectively. The first-first switching transistor ST11b may include a first electrode connected to the m-th initialization scan line GILm, a second electrode connected to the first-second switching transistor ST12b, and a control electrode connected to the driving chip DIC. The first-second switching transistor ST12b may include a first electrode connected to the first-first switching transistor ST11b, a second electrode connected to the first test pad TP1, and a control electrode connected to the driving chip DIC. The control electrode of the first-first switching transistor ST11b may be connected to a first-first dummy terminal S1a of the driving chip DIC to receive a first sub-switching signal TCS11a, and the control electrode of the first-second switching transistor ST12b may be connected to a first-second dummy terminal S1b of the driving chip DIC to receive a second sub-switching signal TCS11b.

The first-first switching transistor ST11b and the first-second switching transistor ST12b may be formed of different types of transistors. As an example of the disclosure, the first-first switching transistor ST11b may be a PMOS transistor, and the first-second switching transistor ST12b may be an NMOS transistor. Accordingly, the first sub-switching signal TCS11a applied to the first-first switching transistor ST11b may have a low level (i.e., ‘a low level activation level’) in the test mode and have a high level (i.e., ‘a high level deactivation level’) in the normal mode. The second sub-switching signal TCS11b applied to the first-second switching transistor ST12b may have a high level (i.e., ‘a high level activation level’) in the test mode and have a low level (i.e., ‘a low level deactivation level’) in the normal mode. As an example of the disclosure, the first sub-switching signal TCS11a may be an inverted signal of the second sub-switching signal TCS11b.

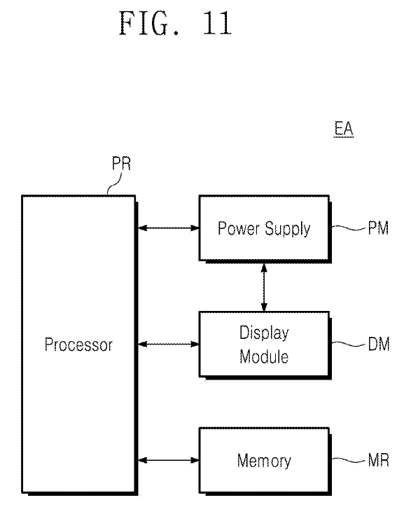

FIG. 11 is a block diagram of an electronic device according to an embodiment.

Referring to FIG. 11, an electronic device EA according to an embodiment may include a display module DM (or ‘a display device’), a processor PR, a memory MR, and a power supply PM.

The processor PR may include at least one of a central processing unit (CPU), an application processor (AP), a graphics processing unit (GPU), a communication processor (CP), an image signal processor (ISP), and a controller.

The memory MR may store data information necessary for the operation of the processor PR or the display module DM. When the processor PR executes an application stored in the memory MR, an image data signal and/or an input control signal are transmitted to the display module DM, and the display module DM may process the received signal and output image information through a display screen. The display module DM may include a display panel that displays an image.

The power supply PM may include a power converter. The power converter may convert power supplied by the power supply such as a power adapter or a battery to generate power required for operation of the electronic device EA.

At least one of the respective components of the electronic device EA described above may be included in the display module according to an embodiment described below and a display device of an embodiment including the same. Some of the individual modules that are functionally included in a module may be included in the display device, and others may be provided separately from the display device. For example, the display device may include a display module DM, and the processor PR, the memory MR, and the power supply PM may be provided in the form of other devices in the electronic device EA external to the display device.

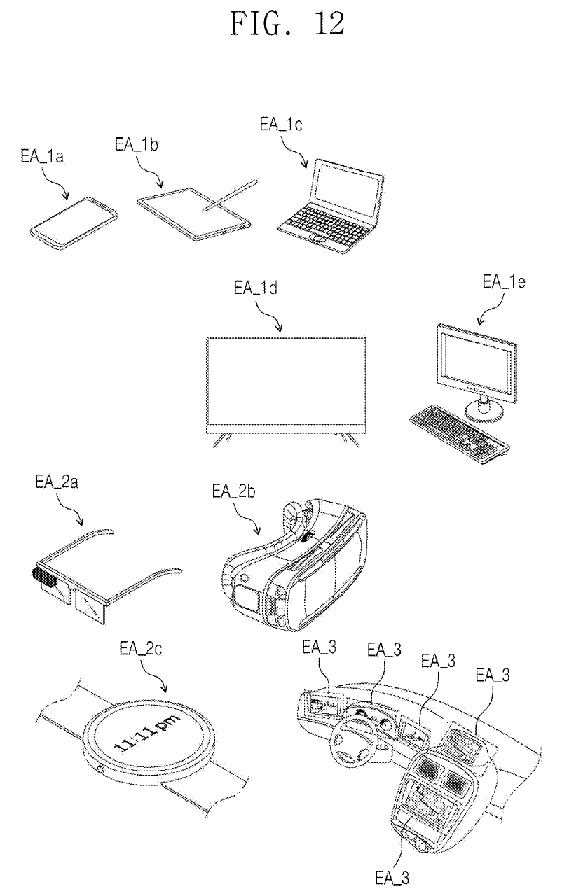

FIG. 12 is a schematic diagram illustrating embodiments of various electronic devices.

Referring to FIG. 12, various electronic devices including a display module (or a display device) according to an embodiment may include not only an electronic device for image display such as a smartphone EA_1a, a tablet EA_1b, a laptop EA_1c, a TV EA_1d, and a computer monitor EA_1e, but also a wearable electronic device such as smart glasses EA_2a, a head mounted display EA_2b, and a smart watch EA_2c, an electronic device for a vehicle EA_3 such as a CID (Center Information Display) disposed on an instrument panel, a center fascia, and a dashboard of a vehicle, and a room mirror display.

According to the invention, a switching circuit is provided between the test pad and the gate driving circuit, and the switching circuit is activated in the test mode and deactivated in the normal mode in response to a switching signal provided from the driving chip. Therefore, the inspection device can analyze the gate signal of the gate driving circuit output from the test pad to inspect whether the gate driving circuit is defective.

While the disclosure has been described above with reference to embodiments thereof, it will be understood by those skilled in the art or those skilled in the relevant art that various modifications and changes can be made to the disclosure without departing from the spirit and technical scope of the disclosure as set forth in the following claims.

Therefore, the technical scope of the disclosure should not be limited to the contents described in the detailed description of the specification, but should be determined by the claims.

What is claimed is:

1. A display device comprising:
a display panel comprising a display area in which a plurality of pixels are disposed and a non-display area adjacent to the display area;
a gate driving circuit disposed in the non-display area of the display panel and configured to provide a gate signal to the plurality of pixels;
a driving chip configured to provide a data signal to the plurality of pixels and configured to provide a gate control signal to the gate driving circuit;
a flexible circuit film connected to the driving chip, the flexible circuit film including a main pad configured to be used in a normal mode and a test pad configured to be used in a test mode; and
a switching circuit connected between the test pad and an output terminal of the gate driving circuit and configured to be activated in the test mode.

2. The display device of claim 1, wherein:
the switching circuit is connected to the driving chip and configured to be activated in the test mode in response to a switching signal provided from the driving chip, and
the switching circuit is configured to be deactivated in the normal mode.

3. The display device of claim 2, wherein the switching circuit comprises:
at least one switching transistor connected between the output terminal and the test pad.

4. The display device of claim 3, wherein the at least one switching transistor comprises:
a first switching transistor including a first electrode connected to the output terminal, a second electrode, and a control electrode configured to receive the switching signal; and
a second switching transistor including a first electrode connected to the second electrode of the first switching transistor, a second electrode connected to the test pad, and a control electrode configured to receive the switching signal.

5. The display device of claim 4, wherein:
each of the first and the second switching transistors is a PMOS transistor or an NMOS transistor.

6. The display device of claim 1, wherein:
the switching circuit is connected to the driving chip and configured to be activated in the test mode in response to first and second sub-switching signals provided from the driving chip,
the switching circuit is configured to be deactivated in the normal mode, and
the first sub-switching signal is an inverted signal of the second sub-switching signal.

7. The display device of claim 6, wherein the switching circuit comprises:
a first switching transistor including a first electrode connected to the output terminal, a second electrode, and a control electrode configured to receive the first sub-switching signal; and
a second switching transistor including a first electrode connected to the second electrode of the first switching transistor, a second electrode connected to the test pad, and a control electrode configured to receive the second sub-switching signal.

8. The display device of claim 7, wherein:
the first and the second switching transistors are transistors of different types.

9. The display device of claim 1, wherein:
the driving chip is mounted in the non-display area of the display panel.

10. The display device of claim 1, wherein the gate driving circuit comprises:
a first gate driving circuit disposed adjacent to a first side of the display area; and
a second gate driving circuit disposed adjacent to a second side of the display area opposite to the first side, wherein:
the test pad includes a first side test pad and a second side test pad.

11. The display device of claim 10, wherein the switching circuit comprises:
a first switching circuit connected between an output terminal of the first gate driving circuit and the first side test pad; and
a second switching circuit connected between an output terminal of the second gate driving circuit and the second side test pad.

12. The display device of claim 11, wherein:
the first switching circuit is connected to the driving chip and is configured to receive a first switching signal from the driving chip,
the second switching circuit is connected to the driving chip and is configured to receive a second switching signal from the driving chip, and
the first and the second switching circuits are activated in the test mode and deactivated in the normal mode.

13. The display device of claim 1, wherein the display panel further comprises:
a plurality of gate lines connected to the gate driving circuit and is configured to receive the gate signal, wherein:
the output terminal of the gate driving circuit is configured to provide the gate signal to one of the plurality of gate lines.

14. The display device of claim 1, wherein the display panel further comprises:
a plurality of gate lines connected to the gate driving circuit and configured to receive the gate signal, wherein:
the output terminal of the gate driving circuit is not connected to any of the plurality of gate lines, and
the output terminal is a dummy output terminal that is configured to output a dummy gate signal.

15. The display device of claim 1, wherein the display panel further comprises:
a bending area that is configured to be bent with respect to a bending axis, wherein:
the switching circuit is disposed between the display area and the bending area.

16. The display device of claim 1, wherein the test mode is a mode monitoring a signal output through the output terminal of the gate driving circuit.

17. The display device of claim 1, wherein:
the gate driving circuit comprises:
at least one scan driving circuit configured to generate at least one scan signal; and
a light emission driving circuit configured to generate a light emission control signal, and
the switching circuit comprises:
a first sub-switching circuit connected to the at least one scan driving circuit; and
a second sub-switching circuit connected to the light emission driving circuit.

18. An electronic device comprising:
a display panel comprising a display area in which a plurality of pixels are disposed and a non-display area adjacent to the display area;
a gate driving circuit disposed in the non-display area of the display panel and configured to provide a gate signal to the plurality of pixels;
a driving chip configured to provide a data signal to the plurality of pixels and configured to provide a gate control signal to the gate driving circuit;
a flexible circuit film connected to the driving chip, the flexible circuit film including a main pad configured to be used in a normal mode and a test pad configured to be used in a test mode;
a switching circuit connected between the test pad and an output terminal of the gate driving circuit and configured to be activated in the test mode; and
a processor configured to provide a control signal and an image signal to the driving chip.

19. The electronic device of claim 18, wherein the display panel further comprises:
a plurality of gate lines connected to the gate driving circuit and configured to receive the gate signal, wherein:
the output terminal of the gate driving circuit is configured to provide the gate signal to one of the plurality of gate lines.

20. The electronic device of claim 18, wherein the display panel further comprises:
a plurality of gate lines connected to the gate driving circuit and configured to receive the gate signal, wherein:
the output terminal of the gate driving circuit is not connected to any of the plurality of gate lines, and
the output terminal is a dummy output terminal that is configured to output a dummy gate signal.
